(19) United States
(12) Patent Application Publication
(10) Pub. No.: US 2014/0091967 A1
(43) Pub. Date: Apr. 3, 2014

(54) Seismic Data Acquisition Module with Broadband Antenna, and Corresponding Systems, Devices, Components and Methods

(71) Applicant: GLOBAL GEOPHYSICAL SERVICES, INC., Missouri City, TX (US)

(72) Inventors: Ralph Buckley Muse, JR., Dallas, TX (US); Graham Michael Scott, Irving, TX (US); Caroline M. Branch, Dallas, TX (US)

(73) Assignee: Global Geophysical Services, Inc., Missouri City, TX (US)

(21) Appl. No.: 13/831,161

(22) Filed: Mar. 14, 2013

Related U.S. Application Data
(60) Provisional application No. 61/707,805, filed on Sep. 28, 2012.

(51) Int. Cl. G01S 19/33

(52) U.S. Cl. CPC G01S 19/33
USPC 342/357.73

(57) ABSTRACT

Described herein are various embodiments of methods and corresponding hardware and software that are configured to permit a seismic data acquisition module to switch between GNSS systems according to which system at a given time is determined to provide the best signal characteristics for acquiring accurate positional and timing data regarding the precise geographic location of the seismic data acquisition module when it is deployed in the field, and the corresponding times at which seismic data are acquired and recorded thereby.

### RELATED APPLICATION

This application claims priority and other benefits from U.S. Provisional Patent Application Ser. No. 61/707,805 entitled “Seismic Data Acquisition Module with High Dynamic Range and Signal-to-Noise Ratio ADC and Broadband Antenna, and Corresponding Systems, Devices, Components and Methods” to Muse et al. filed Sep. 28, 2012 (hereafter “the '805 patent application”), which is hereby incorporated by reference in its entirety.

### FIELD

Various embodiments described herein relate to the field of seismic data acquisition and processing, and systems , devices, components and methods associated therewith.

### BACKGROUND

Modern seismic data acquisition modules often require the use of usable Global Navigation Satellite Systems (“GNSS”) signals to determine accurately the geographical location and timing of the module during seismic data acquisition and recording. Such modules are employed in field locations around the world, on different continents, at different latitudes, and at different longitudes. No one GNSS system covers all parts of the globe with usable signals at any given time. Moreover, each of the major GNSS systems needs to receive a specific set of radio frequencies, and their signal content has to be decoded to a specific protocol which typically differs from system to system.

What is needed are systems, devices, components and methods capable of providing a seismic data acquisition module with universal global GNSS coverage under most or all conditions field locations, wherever they may be in the world.

### SUMMARY

In one embodiment, there is provided a seismic data acquisition module, comprising a processor, a Global Navigation Satellite System (GNSS) module operably connected to the processor, the GNSS module being configured to process GNSS signals originating from a plurality of different GNSS systems, such systems including at least the Global Positioning System (GPS) and the Global Navigation Satellite System (GLONASS), the GNSS signals of the different GNSS systems having respective corresponding GNSS signal characteristics associated therewith according to a field position of the seismic data acquisition module on or near a surface of the earth, one and only one broadband antenna operably connected to the GNSS module and configured to receive GNSS signals from the plurality of different GNSS systems and provide same to the GNSS module, wherein the processor, the GNSS module and the broadband antenna are together configured to receive, process and store positional and timing data provided by the plurality of different GNSS systems, the positional and timing data corresponding to the field position of the seismic data acquisition module and the times at which seismic data are acquired and recorded thereby, at least one of the processor and the GNSS module being configured, during or in preparation for data acquisition by the seismic data acquisition module in the field position, and at a given time, to select one of the GNSS systems determined to provide optimal GNSS signal characteristics at the given time.

In another embodiment, there is provided a method of obtaining positional data for a seismic data acquisition module from a plurality of Global Navigation Satellite System (GNSS) systems, the seismic data acquisition module comprising a processor, a GNSS module operably connected to the processor, the GNSS module being configured to process GNSS signals originating from a plurality of different GNSS systems, such systems including at least the Global Positioning System (GPS) and the Global Navigation Satellite System (GLONASS), the GNSS signals of the different GNSS systems having respective corresponding GNSS signal characteristics associated therewith according to a field position of the seismic data acquisition module on or near a surface of the earth and the times at which seismic data are acquired and recorded thereby, the seismic data acquisition module further comprising one and only one broadband antenna operably connected to the GNSS module and configured to receive GNSS signals from the plurality of different GNSS systems and provide same to the GNSS module, the method comprising using the processor, the GNSS module and the broadband antenna to receive, process and store positional and timing data in a storage device or memory located in the seismic data acquisition module, the positional and timing data being provided by a selected one of the plurality of different GNSS systems.

Further embodiments are disclosed herein or will become apparent to those skilled in the art after having read and understood the specification and drawings hereof.

### BRIEF DESCRIPTION OF THE DRAWINGS

Different aspects of the various embodiments will become apparent from the following specification, drawings and claims in which:

FIG. 1 shows one embodiment of a seismic data acquisition module 10;

FIG. 2 shows one embodiment of circuitry 20 that may be employed in seismic data acquisition module 10;

FIG. 3 shows another embodiment of circuitry 20 that may be employed in seismic data acquisition module 10;

FIG. 4 shows prior art antenna and GNSS circuitry in a seismic data acquisition module;

FIG. 5 shows one embodiment of broadband antenna and GNSS circuitry in a seismic data acquisition module;

FIG. 6 shows one embodiment of a broadband helical antenna for use in conjunction with a seismic data acquisition module and its associated GNSS module, and

FIG. 7 shows one embodiment of a method for acquiring positional data from a plurality of GNSS systems using a broadband antenna and GNSS module in a seismic data acquisition module.

The drawings are not necessarily to scale. Like numbers refer to like parts or steps throughout the drawings, unless otherwise noted.

### DETAILED DESCRIPTIONS OF SOME EMBODIMENTS

In the following description, specific details are provided to impart a thorough understanding of the various embodiments of the invention. Upon having read and understood the specification, claims and drawings hereof, however, those skilled in the art will understand that some embodiments of the invention may be practiced without hewing to some of the specific details set forth herein. Moreover, to avoid obscuring the invention, some well known methods, processes, devices, components and systems finding application in the various embodiments described herein are not disclosed in detail.

In the drawings, some, but not all, possible embodiments are illustrated, and further may not be shown to scale.

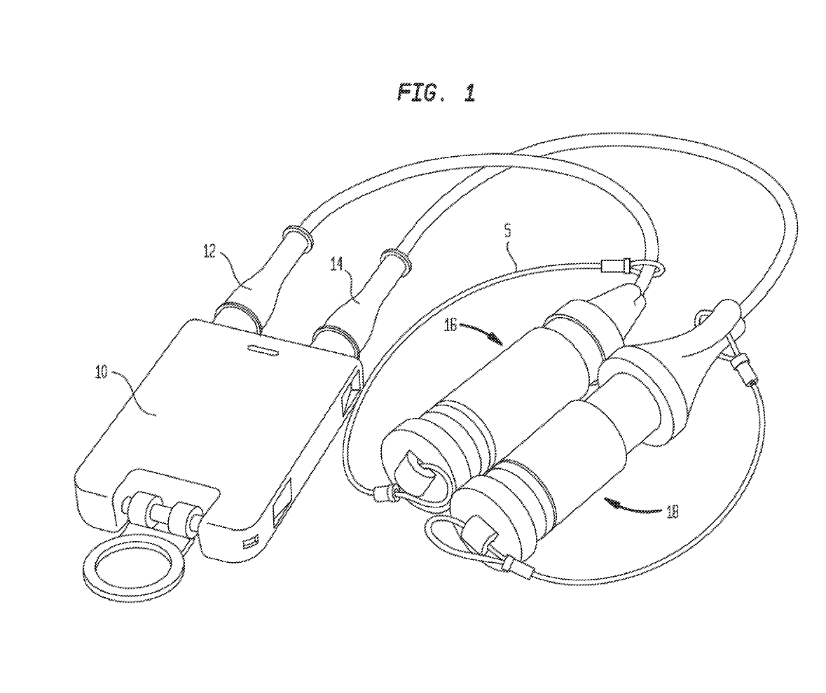

FIG. 1 shows an AUTOSEIS™ HDR (High Definition Recorder) seismic data acquisition module 10 with accompanying geophone cable 14 and connector 18, and external battery power/data downloading cable 12 and connector 16. Caps 9 protect connectors 16 and 18 when they are not in use and disconnected from an external power source, such as a rechargeable lithium ion battery especially designed for the purpose, or a data harvesting device and its associated connector, which is configured for downloading stored seismic data from module 10.

According to one embodiment, basic operation of the AutoSeis HDR seismic data acquisition module 10 is as follows. A geophone is connected to standard geophone connector 18. A geophone is a very sensitive instrument (similar to a microphone) with an analog output of 5 volts peak to peak. This input is feed into module 10 and thence into a PreAmp and then into an analog-to-digital converter (ADC). While module 10 may be configured, by way of example, to record seismic data at 0.5, 1, 2, or 4 milliseconds sample rates, the ADC runs at a much higher rate (called over-sampling). The ADC then outputs a digital signal at a considerably faster rate than the 0.5, 1, 2,or 4 milliseconds sample rate. An FPGA Processor then performs a vertical stack (or average) of a large number of these samples and outputs this “stacked” value to a main processor, where the data are saved to flash storage (or a memory). As a result of this “stacking,” the desired seismic signals are increased and undesired noise is decreased, resulting in a high dynamic range.

According to one embodiment, the ADC has a very accurate reference voltage applied thereto that is important to satisfactory operation. Module 10 uses two references voltages and a monitoring circuit which constantly monitors the two voltages and sends a signal to the processor if any detrimental difference in voltages occurs, at which point module 10 may be put into an alarm state and shut down.

The complete system of module 10 is controlled by a very accurate clock, which is also controlled by a GPS subsystem. The GPS turns on periodically (where such timing is set by a user) and resets the clock to the correct time. The GPS then turns off to save power. This timing system (the Clock and the GPS) controls the timing rates for the ADC and the recorded time in the seismic data.

When module 10 is first deployed in the field it performs a number of system tests, and then uses a signal created by an internal DAC to measure both the resistance and the impedance of the geophone(s) operably connected thereto. This value is recorded and an alarm generated if the value is out of specification.

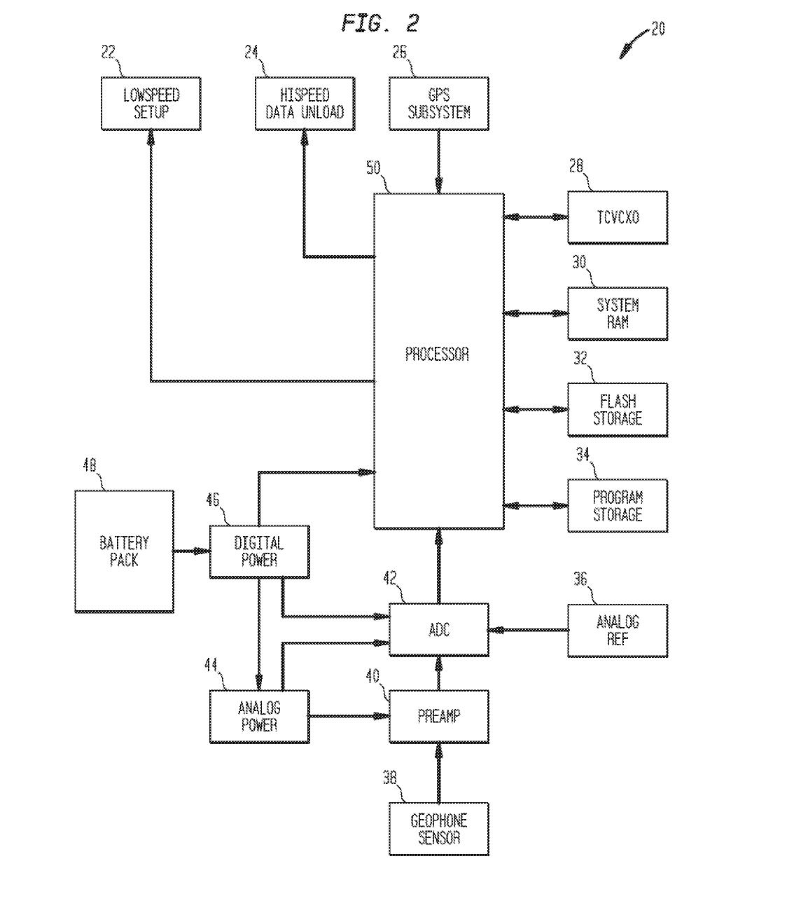

FIG. 2 shows one embodiment of a block diagram of circuitry 20 contained within module 10, which as shown includes LOWSPEED SETUP 22, HISPEED DATA UNLOAD 24, GPS SUBSYSTEM 26, PROCESSOR 50, ADC 42, PREAMP 40, GEOPHONE SENSOR 38, ANALOG POWER 44, DIGITAL POWER 46, BATTERY PACK 48, ANALOG REF 36, PROGRAM STORAGE 34, FLASH STORAGE 32, SYSTEM RAM 30 and TCVCXO 28. Numerous combinations, permutations, adjustments and changes can be made to the embodiment of circuitry 20 shown in FIG. 2, as those skilled in the art will understand after having read and understood the present specification and accompanying drawings.

Further details regarding this and other embodiments of module 10 may be found in the following documents, copies of which are included in the '805 patent application, and which are also hereby incorporated by reference herein each in its respective entirety: (a) “AutoSeis Specification, Details & Scope,” which describes various details relating to one embodiment of an AUTOSEIS™ seismic data acquisition module 10; (b) “AutoSeis Autonomous Nodal Technologies Quick Start Field Manual,” which also describes various details relating to one embodiment of an AUTOSEIS™ seismic data acquisition module 10; (c) “AutoSeis Autonomous Nodal Technologies,” which further describes various details relating to one embodiment of an AUTOSEIS™ seismic data acquisition module 10; (d) one embodiment of a workflow for an AUTOSEIS seismic data acquisition module 10 (as set forth in Appendix D of the '805 patent application).

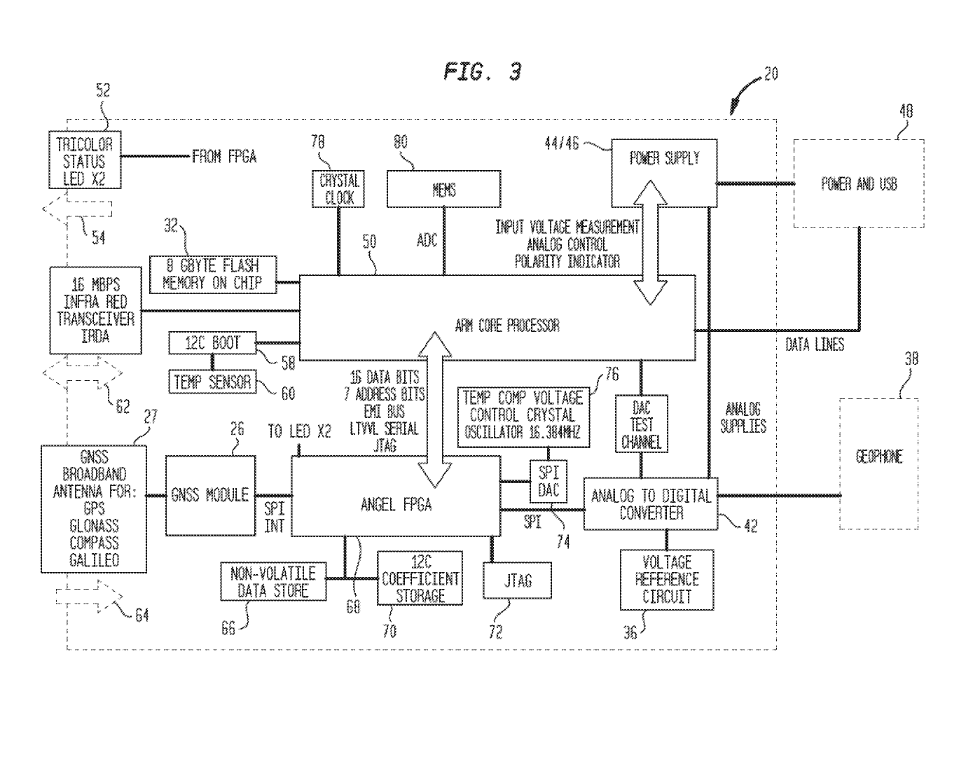

FIG. 3 shows yet another block diagram according to another embodiment of circuitry 20 of seismic data acquisition module 10. In FIG. 3, the acronyms employed therein have the following meanings: DAC=DIGITAL TO ANALOG CONVERTER; EMI=EXTERNAL MEMORY INTERFACE; FPGA=FIELD PROGRAMMABLE GATE ARRAY; GNSS=GLOBAL NAVIGATION SATELLITE SYSTEM; I2C=INTER-INTEGRATED CIRCUIT; INT=INTERRUPT; IRDA=INFRA RED DATA ASSOCIATION; JTAG=JOINT TEST ACTION GROUP INTERFACE; LVTTL=LOW VOLTAGE TRANSISTOR TRANSISTOR LOGIC; MEMS=MICRO ELECTRICAL MECHANICAL SYSTEM; PPS=PULSE PER SECOND; SPI=SERIAL PERIPHERAL INTERFACE; USB=UNIVERSAL SERIAL BUS.

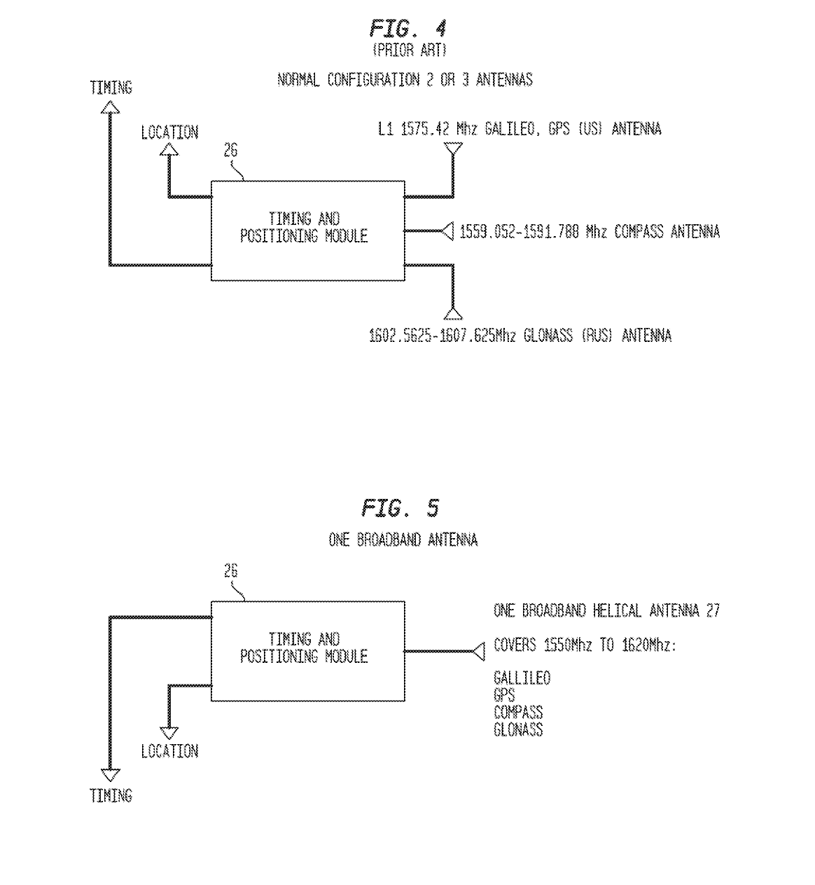

The various portions of circuitry 20 shown in FIG. 3 operate, are interconnected, and are configured to carry out the various functionalities ascribed thereto as follows: ARM CORE PROCESSOR 50 is the main processor of module 10 and controls processes and data storage. MEMS 80 is on-board MEMS sensor used to make the unit aware of orientation and motion, where a signature external “double tap” of the unit is decoded to send current status to the LEDs flush volatile memory to flash and turn on IRDA if dormant. Crystal clock 78 is a 37 kHz clock, and the main processor clock. POWER AND USB 48 is configured to provide external power and communications/data transfer through a 4-pin connector and using a standard USB protocol, with an extended voltages ranging between 5 and 24 volts. GEOPHONE 38 is a geophone that provides analog data through seismic industry standard 2 pin KCK connector. ANALOG TO DIGITAL CONVERTER 42 is an analog signal conditioning and conversion module configured to convert analog signals provided by GEOPHONE 38, and is further capable of digital data filtering and storage. ANGEL FPGA 68 receives digital data, filters the digital data, and prepares the digital data for flash memory storage. GNSS MODULE 26 GNSS module decodes positioning information, including accurate timing data, and provides date and time information that can be used to calibrate the FPGA's clock. GNSS BROADBAND ANTENNA FOR: GPS, GLONASS, COMPASS and GALILEO 27 is a broadband helical antenna capable of receiving frequencies from all or most of the world's major satellite systems. TRICOLOR STATUS LED X252 comprises two sets of 2 tricolor LED clusters capable of displaying unit mode and status to a filed operative observing the unit. POWER SUPPLY 44/46 provides the various voltage supplies, both digital and analog, to run all the onboard sub-systems. In particular, it is configured to sense the polarity of the incoming voltage providing control of the desired operating mode of the unit. Positive voltage compliant with standard USB protocol is decoded as “Download Mode” enabling the USB data lines to be engaged, where module 10 prepares itself for the download of data and the upload of firmware and operating parameters. In the case that the incoming voltage is opposite to the standard USB protocol, module 10 enters a data acquisition mode and records seismic data. TEMP COMP VOLTAGE CONTROL CRYSTAL OSCILLATOR 16.384 MHZ 76 is a high-quality crystal oscillator used to run FPGA 68 at the accuracy required to record satisfactory data, where the oscillator is calibrated and adjusted by the PPS from GNSS MODULE 26. 16 MBPS INFRA RED TRANSCEIVER IRDA 56 is an IRDA transceiver enabled to permit external communication with module 10 other than through the USB interface, which is of particular relevance to obtaining unit or module status and sub-systems status in “Acquisition Mode” as an alternative to the USB interface. SPI DAC 74 is a digital-to-analog converter enabling control of the 16.384 MHz oscillator. 8 GBYTE FLASH MEMORY ON CHIP 32 is commercial grade flash memory in an integrated circuit format providing main storage for acquired data. I2C BOOT 58 is an I2C serial interface boot loader. TEMP SENSOR 60 is an onboard temperature sensor providing real time data for clock compensation and data to be stored for operational use. NON VOLATILE DATA STORE 66 provides additional FPGA data storage. DAC TEST CHANNEL 78 generates digitally produced signals and wave forms that can be converted to analog signals and injected into analog-to-digital converter 42 to test and check the analog section's performance. 16 DATA BITS, 7 ADDRESS BITS, EMI BUS, LVTTL SERIAL, and JTAG are digital control and data lines between FPGA 68 and processor 50. PPS, SPI and INT are digital control and data lines disposed between FPGA 68 and GNSS module 26. INPUT VOLTAGE MEASUREMENT, ANALOG CONTROL and POLARITY INDICATOR are analog and digital control and data lines disposed between power supply 44/46 and processor 50. ANALOG SUPPLIES are high-quality clean analog power supply lines configured to provide power to the analog section. DATA LINES are a standard protocol USB data pair enabled when in USB/download mode. FROM FPGA TO LED X2 (not shown completely in FIG. 4) are data lines configured to provide unit status to LEDs. JTAG 72 is a JTAG header and bus available for board level testing before encapsulation of module 10. SPI is a serial peripheral interface between ADC 42 and FPGA 68. ADC refers to analog lines disposed between MEMS 80 and processor 50's onboard ADC. VOLTAGE REFERENCE CIRCUIT 36 is an independent voltage control circuit to provide additional control of the voltage level supplied to the analog section.

Numerous combinations, permutations, adjustments and changes can be made to the embodiment of circuitry 20 shown in FIG. 3, as those skilled in the art will understand after having read and understood the present specification and accompanying drawings.

Turning now to FIG. 4, there is shown a portion of a conventional seismic data acquisition module containing 2, 3 or 4 separate GNSS antennas, each operably connected to its own appropriate and separate GNSS circuitry. The configuration shown in FIG. 4 permits the seismic data acquisition module to receive positional data from a selected GNSS system. Unfortunately, seismic data acquisition modules of the type illustrated in FIG. 4 are not often employed because of their excessive size, weight and cost. Such a configuration also requires selection of a desired GNSS system before positional data can be obtained.

FIG. 5 shows one embodiment of a portion of a seismic data acquisition module 10 that contains a single broadband antenna 27 compatible with, and configured to operate in conjunction with, multiple different GNSS systems. In one embodiment, the broadband antenna operates in conjunction with a single GNSS module 26. The combination of a single broadband GNSS antenna and a single GNSS module, chip, printed circuit board, or integrated circuit reduces operational complexity and manufacturing costs, the size and weight of seismic data acquisition module 10, and lowers power requirements, which is an important consideration for a field device that may be left unattended for days, weeks or months at a time.

Continuing to refer to FIG. 5, module 10, antenna 27 and GNSS module may be configured to operate in conjunction with any two or more of the US GPS system, the Russian GLONASS system, the Chinese Beidou or Compass system, and/or the European Galileo system. All of these systems employ CDMA and/or a combination of CDMA/FDMA coding.

In such GNSS systems, and as described in Wikipedia, a satellite broadcasts a signal that contains orbital data (from which the position of the satellite can be calculated) and the precise time the signal was transmitted. The orbital data is transmitted in a data message that is superimposed on a code that serves as a timing reference. The satellite uses an atomic clock to maintain synchronization of all the satellites in the constellation. The receiver compares the time of broadcast encoded in the transmission with the time of reception measured by an internal clock, thereby measuring the time-of-flight to the satellite. Several such measurements can be made at the same time to different satellites, allowing a continual fix to be generated in real time using an adapted version of trilateration. Each distance measurement, regardless of the system being used, places the receiver on a spherical shell at the measured distance from the broadcaster. By taking several such measurements and then looking for a point where they meet, a fix is generated. However, in the case of fast-moving receivers, the position of the signal moves as signals are received from several satellites. In addition, the radio signals slow slightly as they pass through the ionosphere, and this slowing varies with the receiver's angle to the satellite, because that changes the distance through the ionosphere. The basic computation thus attempts to find the shortest directed line tangent to four oblate spherical shells centered on four satellites. Satellite navigation receivers reduce errors by using combinations of signals from multiple satellites and multiple correlators, and then using techniques such as Kalman filtering to combine the noisy, partial, and constantly changing data into a single estimate for position, time, and velocity.

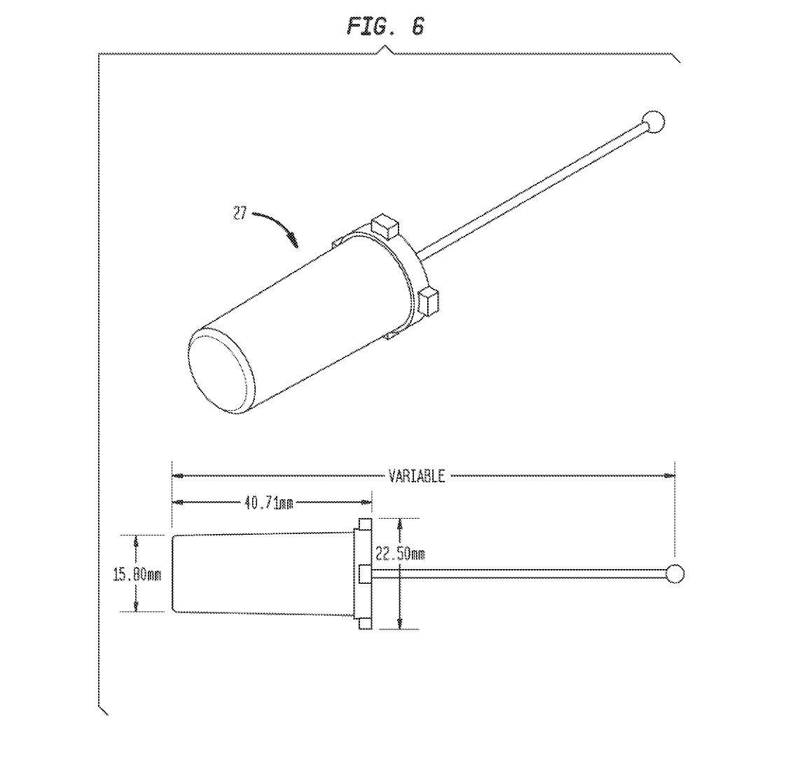

According to some embodiments, GNSS broadband antenna 26 may be a broadband helical M1516HCT-UFL GPS/GLONASS antenna manufactured by Maxtena,™ Inc. of Rockville, Md., U.S.A. A data sheet describing such an antenna is entitled “M1516HCT-UFL GPS/GLONASS Antenna.” This data sheet is filed in an IDS filed on even date herewith, and is hereby incorporated by reference herein in its entirety. See, for example, FIG. 6, where one embodiment of a suitable broadband helical GNSS antenna 27 is shown.

Other types and models of suitable broadband GNSS antennas are also contemplated and may be used in seismic data acquisition module 10, such as high-performance universal ultra-wideband SMM antennas, half-cardioid shaped dual arm antennas, wide-band printed circuit antennas, rover antennas, patch antennas, turnstile antennas, spiral antennas, and choke ring antennas.

Further according to some embodiments, GNSS module 26 may be a NEO-7 u-Blox™ 7 GPS/GNSS module or integrated circuit manufactured by u-Blox of Talwil, Switzerland. A data sheet describing such a GNSS module is entitled “NEO-& u-Blox 7 GPS/GNSS modules Data Sheet “This data sheet also filed in an IDS filed on even date herewith, and is hereby incorporated by reference herein in its entirety. Other types and models of suitable GNSS modules, integrated circuits, and circuits are also contemplated and may be used in seismic data acquisition module 10.

See also “u-Blox 7, Receiver Description, Including Protocol Specification V14” for further details regarding the u-Blox 7 GNSS module, a copy of which is filed in an IDS filed on even date herewith, and which is hereby incorporated by reference herein. Other types and models of suitable GNSS receives and modules are also contemplated, and may be used in seismic data acquisition module 10.

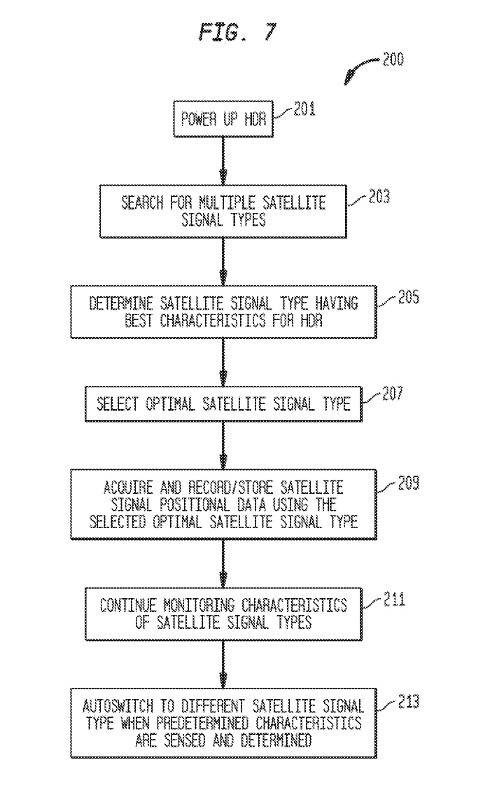

FIG. 7 illustrates a method 200 of operating seismic data acquisition module 10 comprising broadband antenna 27 and GNSS module 27 described above. Steps 201 through 213 of method 200 in FIG. 8 are now described. At step 201, seismic data acquisition module 10 is powered up. At step 203, module 10 commences searching for multiple satellite signal types. At step 205, module 10 determines from among the sensed satellite signal types a satellite signal type having the best characteristics for HDR recording and accurately determining the geographic position of module 10. At step 207, the optimal satellite signal type is selected, at which point the acquisition and recording of seismic data commences in module 10 using the selected optical satellite signal type. While data acquisition and recording are occurring, or during a period of time where acquisition and recording of seismic data by module is not occurring, monitoring of different satellite signal types, signal strengths and signal quality may continue or be re-initiated, as the case may be. If a satellite signal type other than the one currently being employed for data acquisition and recording is detected having superior or improved predetermined signal characteristics is detected by module 10, the module may be configured to switch to the different satellite signal type.

Continuing to refer to FIG. 7, and also to FIGS. 2, 3, 5 and 6, there are described and disclosed herein various embodiments of seismic data acquisition module 10 comprising processor 50 and a Global Navigation Satellite System (GNSS) module 26 operably connected to processor 50, where GNSS module 26 is configured to process GNSS signals originating from a plurality of different GNSS systems. These systems can include, but are not limited to, the Global Positioning System (GPS) and the Global Navigation Satellite System (GLONASS). The GNSS signals of the different GNSS systems have respective corresponding GNSS signal characteristics associated therewith according to a field position of the seismic data acquisition module on or near a surface of the earth. One and only one broadband antenna 27 is operably connected GNSS module 26 and is configured to receive GNSS signals from the plurality of different GNSS systems and provide same to GNSS module 26.

Processor 50, GNSS module 26, and broadband antenna 27 may also be together configured to receive, process and store positional data provided by the plurality of different GNSS systems, where the positional data correspond to the field position of the seismic data acquisition module. At least one of processor 50 and GNSS module 26 may be configured, during or in preparation for data acquisition by seismic data acquisition module 10 in the field position, and at a given time, to select one of the GNSS systems determined to provide optimal GNSS signal characteristics at the given time.

In addition, at least one of processor 50 and GNSS module 26 may be configured to change acquisition of the positional data from the GNSS system selected previously at the given time to another GNSS system at another subsequent time as a result of the another GNSS system having been determined by at least one of GNSS module 26 and processor 50 to provide improved GNSS signal characteristics relative to those provided by the previously selected GNSS system at or near the another time.

These signal characteristics may include one or more of signal strength, signal encoding, signal encoding type, signal duration, number of signals provided by the system, latitude of the position, longitude of the position, and a combination of the latitude and longitude.

The above-described embodiments should be considered as examples, rather than as limiting the scope of the various embodiments. In addition to the foregoing embodiments, review of the detailed description and accompanying drawings will show that there are other embodiments not explicitly disclosed herein. Accordingly, many combinations, permutations, variations and modifications of the foregoing embodiments not set forth explicitly herein will nevertheless fall within the scope of what is claimed herein.

We claim:

1. A seismic data acquisition module, comprising:
a processor;
a Global Navigation Satellite System (GNSS) module operably connected to the processor, the GNSS module being configured to process GNSS signals originating from a plurality of different GNSS systems, such systems including at least the Global Positioning System (GPS) and the Global Navigation Satellite System (GLONASS), the GNSS signals of the different GNSS systems having respective corresponding GNSS signal characteristics associated therewith according to a field position of the seismic data acquisition module on or near a surface of the earth;
one and only one broadband antenna operably connected to the GNSS module and configured to receive GNSS signals from the plurality of different GNSS systems and provide same to the GNSS module;
wherein the processor, the GNSS module and the broadband antenna are together configured to receive, process and store positional and timing data provided by the plurality of different GNSS systems, the positional and timing data corresponding to the field position of the seismic data acquisition module and the times at which seismic data are acquired and recorded thereby, at least one of the processor and the GNSS module being configured, during or in preparation for data acquisition by the seismic data acquisition module in the field position, and at a given time, to select one of the GNSS systems determined to provide optimal GNSS signal characteristics at the given time.

2. The seismic data acquisition module of claim 1, wherein at least one of the processor and the GNSS module is configured to change acquisition of the positional data from the GNSS system selected previously at the given time to another GNSS system at another subsequent time as a result of the another GNSS system having been determined by at least one of the GNSS module and the processor to provide improved GNSS signal characteristics relative to those provided by the previously selected GNSS system at or near the another time.

3. The seismic data acquisition module of claim 1, wherein the signal characteristics include at least one of signal strength, signal encoding, signal encoding type, signal duration, number of signals provided by the system, latitude of the position, longitude of the position, and combination of the latitude and longitude.

4. The seismic data acquisition module of claim 1, wherein the GNSS systems further include the Galileo system.

5. The seismic data acquisition module of claim 1, wherein the GNSS systems further include the Compass system.

6. The seismic data acquisition module of claim 1, wherein the positional data correspond to a field position of the seismic data acquisition module.

7. The seismic data acquisition module of claim 1, wherein the broadband antenna is a helical broadband antenna.

8. The seismic data acquisition module of claim 1, wherein the broadband antenna is a universal ultra-wideband SMM antenna.

9. The seismic data acquisition module of claim 1, wherein the broadband antenna is a half-cardioid shaped dual arm antenna.

10. The seismic data acquisition module of claim 1, wherein the broadband antenna is a wide-band printed circuit antenna.

11. The seismic data acquisition module of claim 1, wherein the broadband antenna is a rover antenna.

12. The seismic data acquisition module of claim 1, wherein the broadband antenna is a patch antenna.

13. The seismic data acquisition module of claim 1, wherein the broadband antenna is a turnstile antenna.

14. The seismic data acquisition module of claim 1, wherein the broadband antenna is a spiral antenna.

15. The seismic data acquisition module of claim 1, wherein the broadband antenna is a choke ring antenna.

16. A method of obtaining positional data for a seismic data acquisition module from a plurality of Global Navigation Satellite System (GNSS) systems, the seismic data acquisition module comprising a processor, a GNSS module operably connected to the processor, the GNSS module being configured to process GNSS signals originating from a plurality of different GNSS systems, such systems including at least the Global Positioning System (GPS) and the Global Navigation Satellite System (GLONASS), the GNSS signals of the different GNSS systems having respective corresponding GNSS signal characteristics associated therewith according to a field position of the seismic data acquisition module on or near a surface of the earth and the times at which seismic data are acquired and recorded thereby, the seismic data acquisition module further comprising one and only one broadband antenna operably connected to the GNSS module and configured to receive GNSS signals from the plurality of different GNSS systems and provide same to the GNSS module, the method comprising:
using the processor, the GNSS module and the broadband antenna to receive, process and store positional and timing data in a storage device or memory located in the seismic data acquisition module, the positional and timing data being provided by a selected one of the plurality of different GNSS systems.

17. The method of claim 16, further comprising selecting the one of the plurality GNSS systems determined to provide optimal GNSS signal characteristics.

18. The method of claim 16, further comprising switching acquisition of the positional data from the GNSS system selected previously to another GNSS system at another subsequent time as a result of the another GNSS system having been determined by at least one of the GNSS module and the processor to provide improved GNSS signal characteristics relative to those provided by the previously selected GNSS system.

19. The method of claim 16, wherein the signal characteristics include at least one of signal strength, signal encoding, signal encoding type, signal duration, number of signals provided by the system, latitude of the position, longitude of the position, and combination of the latitude and longitude.

20. The method of claim 16, wherein the GNSS systems further include the Galileo system.

21. The method of claim 16, wherein the GNSS systems further include the Compass system.
